(19) United States
(12) Patent Application Publication
(10) Pub. No.: US 2020/0216615 A1
(43) Pub. Date: Jul. 9, 2020

(54) MELT POLYMERIZATION METHOD FOR POLYETHERIMIDES

(71) Applicant: SABIC GLOBAL TECHNOLOGIES B.V., Bergen op Zoom (NL)

(72) Inventors: Nitin Vilas Tople, Evansville, IN (US); Bernabe Quevedo Sanchez, Cartagena (ES); Juan Justino Rodriguez Ordonez, San Javier (ES); Javier Nieves Remacha, Madrid (ES); Yusuf Sulub, Newburgh, IN (US)

(21) Appl. No.: 16/647,793

(22) PCT Filed: Sep. 19, 2018
(86) PCT No.: PCT/US2018/051693

§ 371 Date: Mar. 16, 2020

(30) Foreign Application Priority Data
Sep. 20, 2017 (EP) 17382628.0

(51) Int. Cl. C08G 73/10

(52) U.S. Cl. CPC C08G 73/1053; C08G 73/101; C08G 73/1028

(57) ABSTRACT

A method of making a polyetherimide includes melt mixing a composition comprising an aromatic bis(ether anhydride) and a diamine to form a polyetherimide wherein melt mixing occurs at a temperature 50 to 225° C. greater than the glass transition temperature of the polyetherimide and after the composition attains a weight average molecular weight that is greater than or equal to 20% of the weight average molecular weight of the polyetherimide melt mixing occurs at a pressure less than atmospheric pressure.

### BACKGROUND

Polyetherimides can be made by solution polymerization methods or by melt polymerization methods. Melt polymerization methods offer advantages but these advantages have been outweighed by difficulties associated with both the method and the polymer produced by the method. Further improvements to melt polymerization methods are needed.

### BRIEF DESCRIPTION

Disclosed herein is a method of making a polyetherimide comprising melt mixing a composition comprising an aromatic bis(ether anhydride) and a diamine to form a polyetherimide wherein melt mixing occurs at a temperature 50 to 225° C. greater than the glass transition temperature of the polyetherimide and after the composition attains a weight average molecular weight that is greater than or equal to 20% of the weight average molecular weight of the polyetherimide, melt mixing occurs at a pressure less than atmospheric pressure. The compositions are essentially free of solvent. The method produces a polyetherimide that has a change in viscosity of less than or equal to 50% after being maintained for 30 minutes at 390° C. wherein melt viscosity is determined by ASTM D4440. The polyetherimide also has a solvent content less than 50 ppm. The polyetherimide may have a chlorine content less than or equal to 50 ppm.

In some embodiments the method of making a polyetherimide comprises melt mixing a composition comprising a 2,2-bis[4-(3,4-dicarboxyphenoxy)phenyl]propane dianhydride and a diamine comprising m-phenylene diamine, p-phenylene diamine, diaminodiphenyl sulfone or a combination thereof at a temperature of 300 to 450° C. to form a polyetherimide wherein melt mixing occurs at a temperature of 300 to 450° C. and after the composition attains a weight average molecular weight that is greater than or equal to 20% of the weight average molecular weight of the polyetherimide melt, mixing occurs at a pressure less than atmospheric pressure. The composition is essentially free of solvent. The method produces a polyetherimide that has a change in viscosity of −30% to +50% after being maintained for 30 minutes at 390° C. wherein melt viscosity is determined by ASTM D4440. The polyetherimide also has a solvent content less than 50 ppm. The polyetherimide may have a chlorine content less than or equal to 50 ppm.

Also disclosed herein is a polyetherimide having a change in viscosity of less than or equal to 50% after being maintained for 30 minutes at 390° C. wherein melt viscosity is determined by ASTM D4440 and a solvent content less than 50 ppm.

The above described and other features are exemplified by the following FIGURES and detailed description.

### BRIEF DESCRIPTION OF THE DRAWINGS

The following FIGURES are exemplary embodiments wherein the like elements are numbered alike.

FIG. 1 is a schematic representation of a near infrared detection system.

### DETAILED DESCRIPTION

Melt stability is a measurement of the change in viscosity of the polymer after being maintained at a specified elevated temperature for a specified time. Melt stability as described herein is the change in melt viscosity after being held at 390° C. for 30 minutes in a parallel plate rheometer. Melt viscosity is determined according to ASTM D4440. For example, if the melt viscosity of a polymer increases by 60% after exposure to 390° C. for 30 minutes then the melt stability is 60%. If the melt viscosity decreases by 10% then the melt stability is −10%. Previous methods of melt polymerization for polyetherimides have not been able to produce a polyetherimide with an acceptable melt stability, for example a melt stability less than or equal to 50%. This is in contrast to polyetherimides produced by solution polymerization which can have a melt stability of less than or equal to 25%. Since melt stability can have a significant impact on the ability to form articles from a polyetherimide an improved method of melt polymerizing a polyetherimide is desired.

It has been discovered that reducing the pressure below atmospheric pressure (760 mm Hg or 101,325 Pa) during at least a portion of the melt polymerization results in a polyetherimide having improved melt stability, i.e., a polyetherimide having a melt stability less than or equal to 50%. In particular, reducing the pressure to less than or equal to 50,000 Pa, less than or equal to 25,000 Pa, less than or equal to 10,000 Pa, less than 5,000 Pa, or less than or equal to 1,000 Pa can yield a polyetherimide having improved melt stability. The pressure is reduced once the reaction mixture has a weight average molecular weight that is greater than or equal to 20%, or greater than or equal to 60%, or greater than or equal to 90% of the weight average molecular weight of the polyetherimide. In some embodiments the pressure is reduced for the final 50%, 35% or 25% of the polymerization time.

It was further discovered that using an excess of aromatic bis(ether anhydride) relative to the diamine to produce a polyetherimide having a stoichiometry with an excess of anhydride groups relative to the amount of amine groups or a very small excess of amine groups relative to the amount of anhydride groups can improve the melt stability of the polyetherimide. For example, the polyetherimide can have an anhydride-amine stoichiometry of 2.5 to −1 mol %, or 1 to −1 mol %. Anhydride-amine stoichiometry is defined as the mol % of anhydride minus the mol % of amine groups. An anhydride-amine stoichiometry with a negative value indicates an excess of amine groups. Anhydride content and amine content can be determined by Fourier transformed infrared spectroscopy or near infrared spectroscopy.

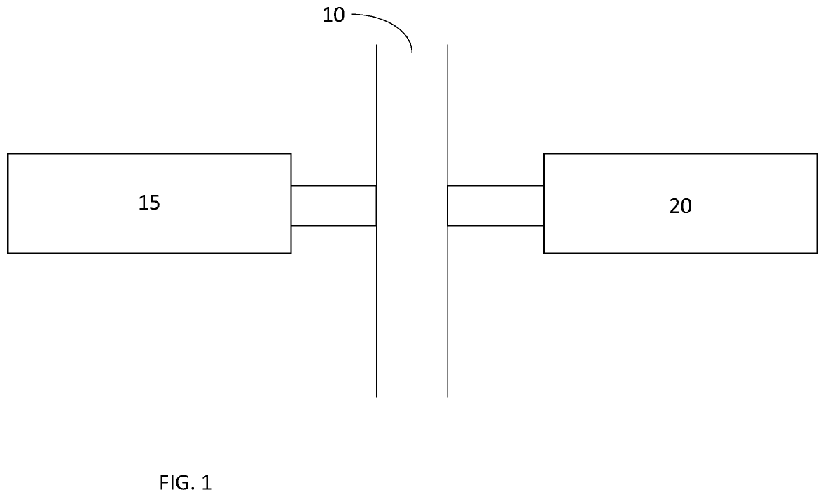

It is desirable to operate the melt polymerization as a continuous process. In order to continuously monitor the ratio of anhydride to amine end groups in the polyetherimide a near infra-red spectroscopy (NIR) detection system may be used to measure the excess anhydride and amine end groups. As shown in FIG. 1, molten polymer continuously moves through a channel 10 having a fixed path length and located between an emitter 15 and a receiver 20. The fixed path length may be 2 to 8, or 4 to 6 millimeters (mm). Using a near-infrared (NIR) spectrometer, NIR light emitted from the spectrometer source is sent to the emitter and passes through the molten polymer in channel 10. The receiver receives NIR light that has not been absorbed by the molten polymer and sends it to the detector of NIR spectrometer where an absorbance spectrum is generated. Absorbance wavelength corresponding to anhydride and amine end groups are compared to calibration curve to determine the polymer stoichiometry in a continuous fashion.

In some embodiments the polyetherimide has a change in melt viscosity of less than or equal to 50%, less than or equal to 40%, less than or equal to 30%, or less than or equal to 20% after being maintained for 30 minutes at 390° C. wherein melt viscosity is determined by ASTM D4440. In some embodiments, the polyetherimide has a change in melt viscosity of −30% to 50% after being maintained for 30 minutes at 390° C. wherein melt viscosity is determined by ASTM D4440.

The polyetherimide has solvent content less than 50 ppm, or less than 30 ppm, or less than 10 ppm. Solvent content may be determined by gas or liquid chromatography. When a polyetherimide is made by a solution process the solvent content is greater than or equal to 50 ppm.

The polyetherimide may have a chlorine content less than or equal to 100 ppm, or less than or equal to 50 ppm, or, less than or equal to 25 ppm. Chlorine content can be determined using X-ray fluorescence spectrometry on a polyetherimide solid sample.

Polyetherimides comprise more than 1, for example 2 to 1000, or 5 to 500, or 10 to 100 structural units of formula (1)

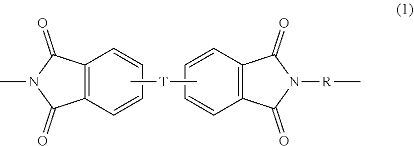

wherein each R is independently the same or different, and is a substituted or unsubstituted divalent organic group, such as a substituted or unsubstituted C₆₋₂₀ aromatic hydrocarbon group, a substituted or unsubstituted straight or branched chain C₄₋₂₀ alkylene group, a substituted or unsubstituted C₃₋₈ cycloalkylene group, in particular a halogenated derivative of any of the foregoing. In some embodiments R is divalent group of one or more of the following formulas (2)

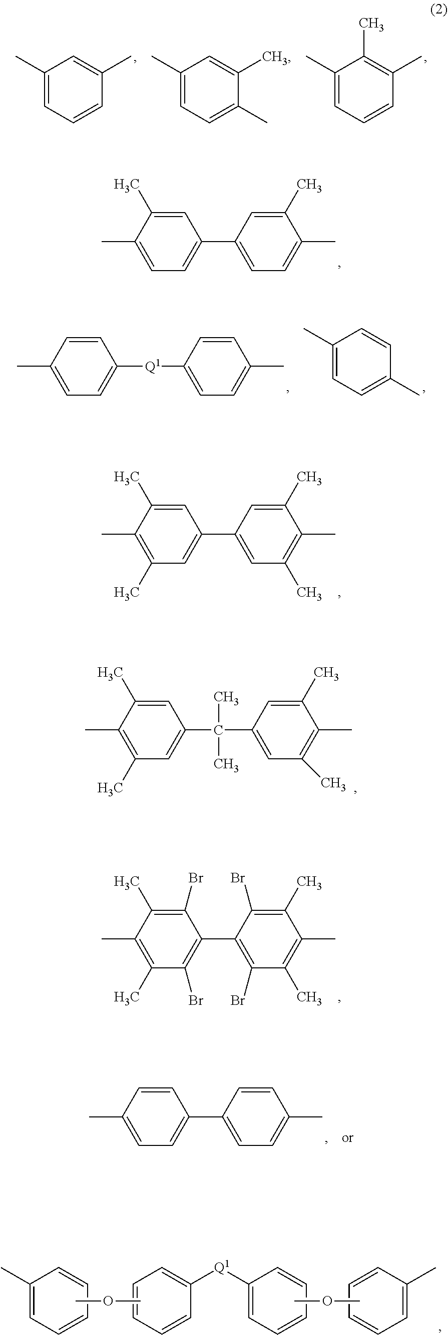

wherein Q¹ is —O—, —S—, —C(O)—, —SO₂—, —SO—, —P(R^{a})(═O)— wherein R^{a} is a C₁₋₈ alkyl or C₆₋₁₂ aryl, —C_{y}H_{2y}— wherein y is an integer from 1 to 5 or a halogenated derivative thereof (which includes perfluoroalkylene groups), or —(C₆H₁₀)_{z}— wherein z is an integer from 1 to 4. In some embodiments R is m-phenylene, p-phenylene, or a diarylene sulfone, in particular bis(4,4′-phenylene)sulfone, bis(3,4′-phenylene)sulfone, bis(3,3′-phenylene)sulfone, or a combination comprising at least one of the foregoing. In some embodiments, at least 10 mole percent or at least 50 mole percent of the R groups contain sulfone groups, and in other embodiments no R groups contain sulfone groups.

Further in formula (1), T is —O— or a group of the formula —O—Z—O— wherein the divalent bonds of the —O— or the —O—Z—O— group are in the 3,3′, 3,4′, 4,3′, or the 4,4′ positions, and Z is an aromatic C₆₋₂₄ monocyclic or polycyclic moiety optionally substituted with 1 to 6 C₁₋₈ alkyl groups, 1 to 8 halogen atoms, or a combination comprising at least one of the foregoing, provided that the valence of Z is not exceeded. Exemplary groups Z include groups of formula (3)

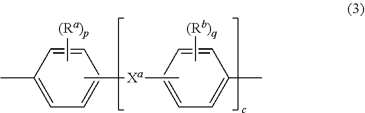

wherein R^{a} and R^{b} are each independently the same or different, and are a halogen atom or a monovalent C₁₋₆ alkyl group, for example; p and q are each independently integers of 0 to 4; c is 0 to 4; and X^{a} is a bridging group connecting the hydroxy-substituted aromatic groups, where the bridging group and the hydroxy substituent of each C₆ arylene group are disposed ortho, meta, or para (specifically para) to each other on the C₆ arylene group. The bridging group X^{a} can be a single bond, —O—, —S—, —S(O)—, —S(O)₂—, —C(O)—, or a C₁₋₁₈ organic bridging group. The C₁₋₁₈ organic bridging group can be cyclic or acyclic, aromatic or non-aromatic, and can further comprise heteroatoms such as halogens, oxygen, nitrogen, sulfur, silicon, or phosphorous. The C₁₋₁₈ organic group can be disposed such that the C₆ arylene groups connected thereto are each connected to a common alkylidene carbon or to different carbons of the C₁₋₁₈ organic bridging group. A specific example of a group Z is a divalent group of formula (3a)

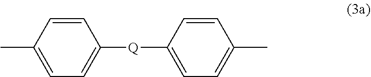

wherein Q is —O—, —S—, —C(O)—, —SO₂—, —SO—, —P(R^{a})(═O)— wherein R^{a} is a C₁₋₈ alkyl or C₆₋₁₂ aryl, or —C_{y}H_{2y}— wherein y is an integer from 1 to 5 or a halogenated derivative thereof (including a perfluoroalkylene group). In a specific embodiment Z is a derived from bisphenol A, such that Q in formula (3a) is 2,2-isopropylidene.

In an embodiment in formula (1), R is m-phenylene, p-phenylene, or a combination comprising at least one of the foregoing, and T is —O—Z—O— wherein Z is a divalent group of formula (3a). Alternatively, R is m-phenylene, p-phenylene, or a combination comprising at least one of the foregoing, and T is —O—Z—O wherein Z is a divalent group of formula (3a) and Q is 2,2-isopropylidene. Alternatively, the polyetherimide can be a copolymer comprising additional structural polyetherimide units of formula (1) wherein at least 50 mole percent (mol %) of the R groups are bis(4,4′-phenylene)sulfone, bis(3,4′-phenylene)sulfone, bis(3,3′-phenylene)sulfone, or a combination comprising at least one of the foregoing and the remaining R groups are p-phenylene, m-phenylene or a combination comprising at least one of the foregoing; and Z is 2,2-(4-phenylene)isopropylidene, i.e., a bisphenol A moiety.

In some embodiments, the polyetherimide is a copolymer that optionally comprises additional structural imide units that are not polyetherimide units, for example imide units of formula (4)

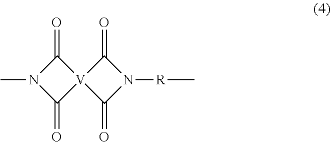

wherein R is as described in formula (1) and each V is the same or different, and is a substituted or unsubstituted C₆₋₂₀ aromatic hydrocarbon group, for example a tetravalent linker of the formulas

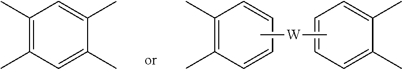

wherein W is a single bond, —O—, —S—, —C(O)—, —SO₂—, —SO—, a C₁₋₁₈ hydrocarbylene group, —P(R^{a})(═O)— wherein R^{a} is a C₁₋₈ alkyl or C₆₋₁₂ aryl, or —C_{y}H_{2y}— wherein y is an integer from 1 to 5 or a halogenated derivative thereof (which includes perfluoroalkylene groups). These additional structural imide units preferably comprise less than 20 mol % of the total number of units, and more preferably can be present in amounts of 0 to 10 mol % of the total number of units, or 0 to 5 mol % of the total number of units, or 0 to 2 mole % of the total number of units. In some embodiments, no additional imide units are present in the polyetherimide.

The polyetherimide is prepared by melt polymerization of an aromatic bis(ether anhydride) of formula (5), with a diamine of formula (6)

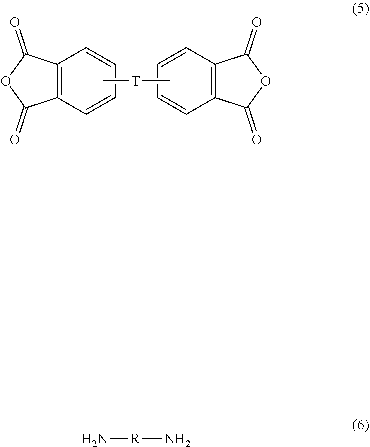

wherein T and R are defined as described above. Copolymers of the polyetherimides can be manufactured using a combination of an aromatic bis(ether anhydride) of formula (5) and an additional bis(anhydride) that is not a bis(ether anhydride), for example pyromellitic dianhydride or bis(3,4-dicarboxyphenyl) sulfone dianhydride.

Illustrative examples of aromatic bis(ether anhydride)s include 2,2-bis[4-(3,4-dicarboxyphenoxy)phenyl]propane dianhydride (also known as bisphenol A dianhydride or BPADA), 3,3-bis[4-(3,4-dicarboxyphenoxy)phenyl]propane dianhydride; 4,4′-bis(3,4-dicarboxyphenoxy)diphenyl ether dianhydride; 4,4′-bis(3,4-dicarboxyphenoxy)diphenyl sulfide dianhydride; 4,4′-bis(3,4-dicarboxyphenoxy)benzophenone dianhydride; 4,4′-bis(3,4-dicarboxyphenoxy)diphenyl sulfone dianhydride; 4,4′-bis(2,3-dicarboxyphenoxy)diphenyl ether dianhydride; 4,4′-bis(2,3-dicarboxyphenoxy)diphenyl sulfide dianhydride; 4,4′-bis(2,3-dicarboxyphenoxy)benzophenone dianhydride; 4,4′-bis(2,3-dicarboxyphenoxy)diphenyl sulfone dianhydride; 4-(2,3-dicarboxyphenoxy)-4′-(3,4-dicarboxyphenoxy)diphenyl-2,2-propane dianhydride; 4-(2,3-dicarboxyphenoxy)-4′-(3,4-dicarboxyphenoxy)diphenyl ether dianhydride; 4-(2,3-dicarboxyphenoxy)-4′-(3,4-dicarboxyphenoxy)diphenyl sulfide dianhydride; 4-(2,3-dicarboxyphenoxy)-4′-(3,4-dicarboxyphenoxy)benzophenone dianhydride; 4,4′-(hexafluoroisopropylidene)diphthalic anhydride; and 4-(2,3-dicarboxyphenoxy)-4′-(3,4-dicarboxyphenoxy)diphenyl sulfone dianhydride. A combination of different aromatic bis(ether anhydride)s can be used.

Examples of diamines include 1,4-butane diamine, 1,5-pentanediamine, 1,6-hexanediamine, 1,7-heptanediamine, 1,8-octanediamine, 1,9-nonanediamine, 1,10-decanediamine, 1,12-dodecanediamine, 1,18-octadecanediamine, 3-methylheptamethylenediamine, 4,4-dimethylheptamethylenediamine, 4-methylnonamethylenediamine, 5-methylnonamethylenediamine, 2,5-dimethylhexamethylenediamine, 2,5-dimethylheptamethylenediamine, 2, 2-dimethylpropylenediamine, N-methyl-bis (3-aminopropyl) amine, 3-methoxyhexamethylenediamine, 1,2-bis(3-aminopropoxy) ethane, bis(3-aminopropyl) sulfide, 1,4-cyclohexanediamine, bis-(4-aminocyclohexyl) methane, m-phenylenediamine (mPD), p-phenylenediamine (pPD), 2,4-diaminotoluene, 2,6-diaminotoluene, m-xylylenediamine, p-xylylenediamine, 2-methyl-4,6-diethyl-1,3-phenylene-diamine, 5-methyl-4,6-diethyl-1,3-phenylene-diamine, benzidine, 3,3′-dimethylbenzidine, 3,3′-dimethoxybenzidine, 1,5-diaminonaphthalene, bis(4-aminophenyl) methane, bis(2-chloro-4-amino-3,5-diethylphenyl) methane, bis(4-aminophenyl) propane, 2,4-bis(p-amino-t-butyl) toluene, bis(p-amino-t-butylphenyl) ether, bis(p-methyl-o-aminophenyl) benzene, bis(p-methyl-o-aminopentyl) benzene, 1, 3-diamino-4-isopropylbenzene, bis(4-aminophenyl) sulfide, bis-(4-aminophenyl) sulfone (also known as 4,4′-diaminodiphenyl sulfone (DDS)), and bis(4-aminophenyl) ether. Any regioisomer of the foregoing compounds can be used. C₁₋₄ alkylated or poly(C₁₋₄)alkylated derivatives of any of the foregoing can be used, for example a polymethylated 1,6-hexanediamine Combinations of these compounds can also be used. In some embodiments the organic diamine is m-phenylenediamine, p-phenylenediamine, 4,4′-diaminodiphenyl sulfone, 3,4′-diaminodiphenyl sulfone, 3,3′-diaminodiphenyl sulfone, or a combination comprising at least one of the foregoing.

The polyetherimide may have terminal groups derived from a chain stopper. The chain stopper may be a monoamine or a monoanhydride. Exemplary chain stoppers include phthalic anhydride and aniline. The amount of chain stopper can be 2 to 8 mol % based on the total amount of the relevant functional group. For example, when the chain stopper is a monoanhydride, the mol % of chain stopper is defined as moles of monoanhydride/(moles of monoanhydride+2x moles of bis(ether anhydride)).

The polyimides/polyetherimides can have a melt index of 0.1 to 10 grams per minute (g/min), as measured by American Society for Testing Materials (ASTM) D1238 at 340 to 370° C., using a 6.7 kilogram (kg) weight. In some embodiments, the polyetherimide has a weight average molecular weight (Mw) of 1,000 to 150,000 grams/mole (Dalton), as measured by gel permeation chromatography (GPC), using polystyrene standards. In some embodiments the polyetherimide has an Mw of 10,000 to 80,000 Daltons. Such polyetherimides typically have an intrinsic viscosity greater than 0.2 deciliters per gram (dl/g), or, more specifically, 0.35 to 0.7 dl/g as measured in m-cresol at 25° C.

The polyetherimide can have a glass transition temperature of 180 to 310° C. as determined by differential scanning calorimetry (ASTM D3418).

The melt polymerization can be performed in an extruder, mechanically agitated reactor or other melt mixing device. A composition comprising an aromatic bis(ether anhydride) and a diamine are melt mixed at a temperature 50 to 225° C., or 50 to 150° C., greater than the glass transition temperature of the polyetherimide. In some embodiments melt mixing occurs at 300 to 450° C. The aromatic bis(ether anhydride) and the diamine may be present amounts sufficient to obtain an anhydride to amine ratio of 0.995 to 1.025. The composition is essentially free of solvent. “Essentially free of solvent” is defined as containing less than or equal to 0.1 weight percent based on the total weight of the composition. In some embodiments no solvent can be detected by gas chromatography or liquid chromatography. The polymerization occurs for the time necessary to achieve the desired molecular weight and melt stability.

As described above, some of the polymerization occurs at a pressure less than atmospheric pressure. In some embodiments the final 10% to 75% of the polymerization time is conducted at a pressure less than or equal to 50,000 Pa, less than or equal to 25,000 Pa, less than or equal to 10,000 Pa, less than or equal to 5,000 Pa, or less than or equal to 1,000 Pa. The pressure is reduced once the reaction mixture has a weight average molecular weight that is greater than or equal to 20%, or greater than or equal to 60%, or greater than or equal to 90% of the weight average molecular weight of the polyetherimide. Melt mixing may occur at a temperature 50 to 225° C., or 50 to 150° C., greater than the glass transition temperature of the polyetherimide. In some embodiments melt mixing occurs at 300 to 450° C. The melt mixing device may be vented to allow for removal of the water of reaction.

This disclosure is further illustrated by the following examples, which are non-limiting.

### EXAMPLES

### Example 1

Solvent-free polymerization reactions were carried-out in a glass reactor equipped with a mechanical agitator. The reactor was charged with 45 grams of a dry mix of monomers. This mix of monomers was prepared by dissolving the monomers (BPADA and mPD) and chain stopper (PA) in dichloromethane, stirring in an ultrasonic bath for 2 hours, removing the solvent in a rotovap at 50° C. and 75,000 Pa, and drying in a vacuum oven at 30° C. and 10,000 Pa overnight. The BPADA comprised greater than or equal to 95 mol % of the 4,4′ isomer.

The temperature of the reactor was ramped to melt the dry mixture of monomers at 225° C. for 10 minutes. Agitation was started and increased up to 20 rpm during the melting phase at 225° C. Afterwards, temperature was increased to the reaction set point (325° C. or 350° C.). Agitation was sequentially increased to reach a maximum of 80 rpm during reaction. Once at 80 rpm, pressure was reduced from atmospheric pressure to 1,000 Pa. Vacuum was kept constant until the end of the reaction. The resulting polymer was characterized by GPC to measure molecular weight distribution, by liquid chromatography to measure solvent content, by FTIR to measure anhydride and amine end groups, by ASTM D1925 to measure yellowness index (YI) and by parallel plate rheometry to measure melt stability as described above. No solvent was detected in the samples.

A total of 11 reactions were run with different formulations to test the effect of reaction time, temperature and stoichiometry on melt stability (see Table 1 for results). Results indicated that the most significant factor affecting melt stability was the polymer stoichiometry, which was modified from 1 mol % amine excess to 0.57 mol % excess anhydride.

The effect of the polymer stoichiometry on the molecular weight distribution was also observed. A stoichiometry rich in anhydride was necessary in order to have narrow polydispersity index (PDI).

TABLE 1

| | A | B | C | D | E | F | G | H | I | J | I |
|---|---|---|---|---|---|---|---|---|---|---|---|
| Reaction | 2.2% CS | 3% CS | 3% CS | 3% CS | 3% CS | 2.2% CS | 2.2% CS | 3% CS | 3% CS | 3% CS | 3% CS |
| stoichiometry | | | | | | | | | | | |
| Reaction time | 64 | 64 | 64 | 95 | 95 | 64 | 64 | 64 | 64 | 64 | 64 |
| (min) | | | | | | | | | | | |
| Reaction | 350 | 350 | 325 | 350 | 325 | 350 | 325 | 350 | 325 | 325 | 325 |
| temperature ° C. | | | | | | | | | | | |
| Mw (Daltons) | 56552 | 58631 | 77298 | 103007 | 64243 | 76114 | 87167 | 65903 | 59716 | 57691 | 65769 |
| Mn (Daltons) | 20228 | 22044 | 25784 | 25617 | 23656 | 27496 | 31466 | 24546 | 23263 | 23763 | 25304 |
| PDI | 2.80 | 2.66 | 3.00 | 4.02 | 2.72 | 2.77 | 2.77 | 2.68 | 2.57 | 2.43 | 2.60 |
| Polymer molar | 1.12 | 0.35 | 0.10 | 0.17 | 0.29 | 0.00 | 0.00 | 0.136 | 0.148 | 0.054 | 0.00 |
| excess of | | | | | | | | | | | |
| amine (%) | | | | | | | | | | | |
| Polymer molar | 0.13 | 0.16 | 0.18 | 0.18 | 0.16 | 0.39 | 0.32 | 0.19 | 0.18 | 0.63 | 0.24 |
| excess of | | | | | | | | | | | |
| anhydride (%) | | | | | | | | | | | |
| Polymer | −1.0 | −0.2 | 0.1 | 0.01 | −0.13 | 0.39 | 0.32 | 0.05 | 0.03 | 0.57 | 0.24 |
| stoichiometry | | | | | | | | | | | |
| Yellowness | 128 | 116 | 107 | 139 | 156 | 120 | 107 | 153 | 120 | 108 | 102 |
| Index | | | | | | | | | | | |
| Melt stability at | 63 | 48 | 25 | 21 | 42 | 20 | 16 | 31 | 35 | 32 | 25 |
| 390° C. (%) | | | | | | | | | | | |

### Example 2

Solvent-free polymerization reactions were carried-out in a glass reactor equipped with a mechanical agitator. The reactor was charged with 45 grams of a dry mix of monomers. This mix of monomers (BPADA and mPD) was prepared by dissolving the monomers and chain stopper (PA) in dichloromethane, stirring in an ultrasonic bath for 2 hours, removing the solvent in a rotovap at 50° C. and 75,000 Pa, and drying in a vacuum oven at 30° C. and 10,000 Pa overnight. The BPADA comprised greater than or equal to 95 mol % of the 4,4′ isomer. Four different formulations were used in this example, all of them with excess dianhydride (DA). The formulations are shown in Table 3. “CS” refers to the molar amount of the chain stopper, phthalic anhydride. For each formulation, reactions carried out at atmospheric pressure were compared with reactions where pressure was reduced to 1000 Pa.

The temperature was ramped to 225° C. for 10 minutes to melt the dry mixture of monomers. Afterwards, temperature was increased to 325° C. and maintained for 40 minutes at constant temperature. Agitation was started after the monomers melted and increased sequentially to reach a maximum of 80 rpm during reaction. One set of reactions was carried out at constant atmospheric pressure with a nitrogen sweep. Another set of reaction included the reduction of pressure down to 1000 Pa during the last 22 minutes of reaction. The resulting polymer was characterized by GPC to measure molecular weight distribution, by liquid chromatography to measure solvent content, by FTIR to measure anhydride and amine end groups, by ASTM D1925 to measure yellowness index (YI) and by parallel plate rheometry to measure melt stability as described above. No solvent was detected in the samples. Results are shown in Table 2.

TABLE 2

| | A | B | C | D | E | F | G | H | I | J |
|---|---|---|---|---|---|---|---|---|---|---|
| Reaction | 2.2% CS | 2.2% CS | 3% CS | 3% CS | 3% CS | 3% CS | 3% CS | 3% CS | 3% CS | 3% CS |
| stoichiometry | | | | | | | | | | |
| Pressure (Pa) | 1000 | 101,300 | 1000 | 101,300 | 1000 | 101,300 | 1000 | 101,300 | 1000 | 101,300 |
| Mw (Daltons) | 87167 | 75898 | 59716 | 57202 | 57691 | 52428 | 65769 | 53774 | 35305 | 35558 |
| Mn (Daltons) | 31466 | 28557 | 23263 | 22255 | 23763 | 21120 | 25304 | 21694 | 15513 | 15283 |
| PDI | 2.77 | 2.66 | 2.57 | 2.57 | 2.43 | 2.48 | 2.60 | 2.48 | 2.28 | 2.33 |
| Polymer molar | 0.00 | 0.05 | 0.15 | 0.23 | 0.05 | 0.03 | 0.00 | 0.11 | 0 | 0 |
| excess of | | | | | | | | | | |
| amine (%) | | | | | | | | | | |
| Polymer molar | 0.32 | 0.45 | 0.18 | 0.45 | 0.63 | 0.75 | 0.24 | 0.42 | 2.54 | 2.26 |
| excess of | | | | | | | | | | |
| anhydride (%) | | | | | | | | | | |
| Polymer | 0.32 | 0.41 | 0.03 | 0.22 | 0.57 | 0.72 | 0.24 | 0.31 | 2.54 | 2.26 |
| stoichiometry | | | | | | | | | | |
| Yellowness | 107 | 150 | 120 | 161 | 108 | 130 | 102 | 123 | 100 | 148 |
| Index | | | | | | | | | | |
| Melt stability | 16 | 25 | 35 | 71 | 32 | 45 | 25 | 71 | 35 | 53 |
| at 390° C. (%) | | | | | | | | | | |

A paired T-Test was run to evaluate whether the groups of reactions carried-out at different pressures had an effect on polymer melt stability. Results indicated that there was a significant difference between the two groups. Polymer obtained via introduction of vacuum had an average of 24.3% reduction in melt stability compared to polymer obtained at atmospheric pressure.

### Example 3

Solvent-free polymerization reactions were carried-out in a glass reactor equipped with a mechanical agitator. The reactor was charged with 50 grams of a dry mix of BPADA and p-phenylene diamine (pPD) and phthalic anhydride as the chainstopper. The BPADA comprised greater than or equal to 95 mol % of the 4,4′ isomer. Different formulations were used in this example resulting in different stoichiometry of the final polymer. “CS” refers to the molar amount of the chain stopper, phthalic anhydride.

The temperature was ramped to 250° C. for 10 minutes to melt the dry mixture of monomers. Afterwards, temperature was increased to 325° C. or 350° C. as specified in Table 4 and maintained for 50 and 40 minutes respectively at constant temperature. Agitation was started after the monomers melted and increased sequentially to reach a maximum of 80 rpm during reaction. Pressure was reduced to 1000 Pa during the last 25 and 35 minutes of reaction for the 350° C. and 325° C. runs respectively. The resulting polymer was characterized by GPC to measure molecular weight distribution, by liquid chromatography to measure solvent content, by FTIR to measure anhydride and amine end groups, and by parallel plate rheometry to measure melt stability as described above. No solvent was detected in the samples. Results are shown in Table 4. Results indicated that polymer stoichiometry is a significant factor affecting melt stability. Polymer stoichiometry between −0.8 mol % and +0.2 mol % led to melt stability below or equal to 14%.

TABLE 3

| | A | B | C | D | E | F | G | H | I |
|---|---|---|---|---|---|---|---|---|---|
| Reaction | 3% CS | 3% CS | 3% CS | 3% CS | 3% CS | 3% CS | 3% CS | 3% CS | 3% CS |
| stoichiometry | | | | | | | | | |
| Temperature | 350° C. | 350° C. | 350° C. | 350° C. | 325° C. | 325° C. | 325° C. | 325° C. | 325° C. |
| Mw (Daltons) | 52,834 | 44,438 | 36,141 | 41,496 | 33,314 | 31,530 | 42,963 | 45,926 | 40,508 |
| Mn (Daltons) | 22,751 | 17,165 | 15,384 | 15,782 | 14,304 | 14,022 | 18,892 | 19.923 | 17,246 |
| PDI | 2.3 | 2.6 | 2.3 | 2.6 | 2.3 | 2.2 | 2.3 | 2.3 | 2.3 |
| Polymer molar | 0.46 | 0.84 | 0.18 | 0.68 | 0.3 | 0.3 | 3.0 | 0.3 | 0.3 |
| excess of | | | | | | | | | |
| amine (%) | | | | | | | | | |
| Polymer molar | 0 | 0.04 | 1.62 | 0.16 | 3.0 | 2.6 | 0 | 0.5 | 1.4 |
| excess of | | | | | | | | | |
| anhydride (%) | | | | | | | | | |
| Polymer | −0.46 | −0.80 | 1.44 | −0.52 | 2.7 | 2.3 | −3 | 0.2 | 1.1 |
| stoichiometry | | | | | | | | | |
| Melt stability | −28 | −14 | 224 | −4 | 548 | 422 | 60 | 14 | 36 |
| at 390° C. (%) | | | | | | | | | |

### Example 4

Solvent-free polymerization reactions were carried-out in a glass reactor equipped with a mechanical agitator. The reactor was charged with a dry mix of BPADA and bis-(4-aminophenyl) sulfone (DDS), and phthalic anhydride (PA) as the chainstopper. The BPADA comprised 99 mol % of the 3,3′ isomer. Different formulations were used in this example resulting in different stoichiometry of the final polymer. “CS” refers to the molar amount of the chain stopper, phthalic anhydride.

The temperature was ramped to 270° C. for 10 minutes to melt the dry mixture of monomers. Afterwards, temperature was increased to 325° C. and maintained for 40 minutes constant temperature. Agitation was started after the monomers melted and increased sequentially to reach a maximum of 80 rpm during reaction. Pressure was reduced to 1000 Pa during the last 25 minutes of reaction. The resulting polymer was characterized by GPC to measure molecular weight distribution, by liquid chromatography to measure solvent content, by FTIR to measure anhydride and amine end groups, and by parallel plate rheometry to measure melt stability as described above. No solvent was detected in the samples. Results are shown in Table 4.

TABLE 4

| | A | B |
|---|---|---|
| Reaction stoichiometry | 3% CS | 3% CS |
| Mw (Daltons) | 45,521 | 44,201 |
| Mn (Daltons) | 19,603 | 18,129 |
| PDI | 2.3 | 2.4 |
| Polymer molar excess of amine (%) | 0 | 0.4 |
| Polymer molar excess of anhydride (%) | 1.6 | 0.7 |
| Polymer stoichiometry | 1.6 | 0.3 |
| Melt stability at 390° C. (%) | −7 | −39 |

### Example 5

Solvent-free polymerization reactions were carried-out in a glass reactor equipped with a mechanical agitator. The reactor was charged with 45 grams of a dry mix of monomers. This mix of monomers was prepared by dissolving the monomers (BPADA and 4,4′-diaminodiphenyl sulfone (DDS)) and chain stopper (PA) in dichloromethane, stirring in an ultrasonic bath for 1 hours, removing the solvent in a rotovap at 45° C. and 75,000 Pa, and drying in a vacuum oven at 25° C. and 10,000 Pa overnight. The BPADA comprised greater than or equal to 95 mol % of the 4,4′ isomer. Different formulations were used in this example resulting in different stoichiometry of the final polymer. “CS” refers to the molar amount of the chain stopper, phthalic anhydride.

The temperature of the reactor was ramped to melt the dry mixture of monomers at 250° C. for 18 minutes. Afterwards, temperature was increased to 325° C. or 350° C. as specified in Table 6 and maintained for 45 minutes at constant temperature. Agitation was started after the monomers melted and increased sequentially increased to reach a maximum of 80 rpm during reaction. Once at 80 rpm, pressure was maintained at atmospheric pressure or reduced to 1,000 Pa as specified in Table 5. When vacuum was applied, it was kept constant until the end of the reaction. The resulting polymer was characterized by GPC to measure molecular weight distribution, by liquid chromatography to measure solvent content, by FTIR to measure anhydride and amine end groups, by ASTM D1925 to measure yellowness index (YI) and by parallel plate rheometry to measure melt stability as described above. No solvent was detected in the samples. Results are shown in Table 6. Results indicated that stoichiometry and pressure are significant factors affecting melt stability. Polymer obtained via introduction of vacuum had an average of 52% improvement in melt stability compared to polymer obtained at atmospheric pressure. Polymer stoichiometry between −0.9 mol % and −0.2 mol % led to melt stability below or equal to 21%.

TABLE 5

| | A | B | C | D | E | F | G | H | I | J |
|---|---|---|---|---|---|---|---|---|---|---|
| Reaction | 3% CS | 3% CS | 3% CS | 3% CS | 3% CS | 3% CS | 3% CS | 3% CS | 3% CS | 3% CS |
| stoichiometry | | | | | | | | | | |
| Temperature | 325° C. | 350° C. | 350° C. | 325° C. | 325° C. | 350° C. | 350° C. | 325° C. | 350° C. | 350° C. |
| Pressure (Pa) | 1,000 | 1,000 | 1,000 | 1,000 | 101,300 | 101,300 | 101,300 | 101,300 | 1,000 | 1,000 |
| Mw (Daltons) | 46923 | 42412 | 49353 | 44504 | 38859 | 39501 | 39330 | 36047 | 43941 | 49659 |
| Mn (Daltons) | 19604 | 17508 | 20296 | 19123 | 16711 | 16645 | 16891 | 15934 | 18434 | 19883 |
| PDI | 2.39 | 2.42 | 2.42 | 2.32 | 2.32 | 2.37 | 2.33 | 2.27 | 2.38 | 2.50 |
| Polymer molar | 0.62 | 1.35 | 0.12 | 0 | 1.09 | 0.75 | 0.29 | 0.55 | 0.86 | 0.40 |
| excess of | | | | | | | | | | |
| amine (%) | | | | | | | | | | |
| Polymer molar | 0.07 | 0.02 | 1.07 | 0.95 | 1.07 | 1.23 | 1.50 | 1.51 | 0.03 | 0.18 |
| excess of | | | | | | | | | | |
| anhydride (%) | | | | | | | | | | |
| Polymer | −0.55 | −1.33 | 0.95 | 0.95 | −0.02 | 0.48 | 1.21 | 0.96 | −0.82 | −0.22 |
| stoichiometry | | | | | | | | | | |
| Yellowness | 92 | 95 | 105 | 91 | 123 | 115 | 152 | 102 | 101 | 111 |
| Index | | | | | | | | | | |
| Melt stability | 21 | 26 | 55 | 79 | 72 | 107 | 97 | 113 | 5 | 11 |
| at 390° C. (%) | | | | | | | | | | |

### Example 6

Polyetherimide samples with pre-determined excess anhydride and excess amine endgroups were fed to a Leistritz AG manufactured extruder. It was a Micro 27/36D (27 mm diameter screws, 36 L/D ratio) twin-screw extruder. The extruder had 9 barrels. The powder feed is at barrel 3, and a vacuum port is located at barrel 7. The die, which had a near infrared (NIR) transmittance probe, was attached downstream of barrel 9.

The NIR transmittance probe was a cross-line demountable probe configured for NIR spectral range 800-4500 nm transmission measurements. The probe had a sapphire window held with a Grafoil weld to the 316 L stainless steel probe body. FIG. 1 displays the setup of the probe for transmission measurements.

Near infrared spectra were acquired using a Sentronic SentroPAT NIR spectrometer (Sentronic GmbH Dresden, Germany) equipped tungsten halogen source, diode array and an indium gallium arsenide (InGaAs) detector, capable of generating spectra across a wavelength range of 1100-2200 nanometers (nm). For the example, a wavelength range 1350-2037 nm was used.

TABLE 6

| | | | Actual | | Inline NIR measurement | |
|---|---|---|---|---|---|---|
| | Feed | Screw | Excess | Excess | Excess | Excess |
| | rate | speed | anhydride | Amine | anhydride | Amine |
| | kg/hr | RPM | mole % | mole % | mole % | mole % |
| Run 1 | 9 | 200 | 0.140 | 0.051 | 0.224 | 0.000 |
| Run 2 | 9 | 300 | 0.150 | 0.081 | 0.221 | 0.000 |
| Run 3 | 12 | 300 | 0.150 | 0.076 | 0.222 | 0.000 |
| Run 4 | 9 | 200 | 0.174 | 0.003 | 0.226 | 0.000 |
| Run 5 | 9 | 300 | 0.164 | 0.016 | 0.224 | 0.000 |
| Run 6 | 12 | 300 | 0.193 | 0.035 | 0.222 | 0.000 |
| Run 7 | 9 | 300 | 0.393 | 0.000 | 0.253 | 0.000 |
| Run 8 | 9 | 200 | 0.930 | 0.000 | 1.017 | 0.000 |
| Run 9 | 9 | 300 | 0.891 | 0.000 | 0.888 | 0.000 |
| Run 10 | 12 | 300 | 0.917 | 0.000 | 0.936 | 0.000 |
| Run 11 | 9 | 300 | 1.120 | 0.000 | 1.119 | 0.000 |
| Run 12 | 9 | 300 | 1.791 | 0.000 | 1.795 | 0.000 |
| Run 13 | 9 | 300 | 0.087 | 0.286 | 0.000 | 0.346 |
| Run 14 | 9 | 300 | 0.000 | 1.548 | 0.000 | 1.498 |
| Run 15 | 9 | 200 | 0.000 | 1.576 | 0.000 | 1.521 |
| Run 16 | 9 | 300 | 0.000 | 1.609 | 0.000 | 1.547 |
| Run 17 | 12 | 300 | 0.000 | 1.644 | 0.000 | 1.562 |
| Run 18 | 9 | 300 | 0.054 | 0.194 | 0.000 | 0.211 |
| Run 19 | 9 | 300 | 0.000 | 0.648 | 0.000 | 0.647 |
| Run 20 | 9 | 200 | 0.000 | 0.451 | 0.000 | 0.405 |
| Run 21 | 9 | 300 | 0.000 | 0.462 | 0.000 | 0.440 |
| Run 22 | 12 | 300 | 0.000 | 0.446 | 0.000 | 0.451 |
| Run 23 | 9 | 300 | 0.000 | 2.682 | 0.000 | 2.738 |

The data shows that the inline measurement of the anhydride and amine groups closely mirrors the standard off line measurement of these groups.

This disclosure further encompasses the following embodiments.

### Embodiment 1

A method of making a polyetherimide comprising melt mixing a composition comprising an aromatic bis(ether anhydride) and a diamine to form a polyetherimide wherein melt mixing occurs at a temperature 50 to 225° C. greater than the glass transition temperature of the polyetherimide and after the composition attains a weight average molecular weight that is greater than or equal to 20% of the weight average molecular weight of the polyetherimide melt mixing occurs at a pressure less than atmospheric pressure.

### Embodiment 2

The method of Embodiment 1, wherein the aromatic bis(ether anhydride) comprises bisphenol A dianhydride.

### Embodiment 3

The method of Embodiment 1 or 2, wherein the diamine comprises m-phenylenediamine (mPD), p-phenylenediamine (pPD), 4,4′-diaminodiphenyl sulfone, 3,4′-diaminodiphenyl sulfone, 3,3′-diaminodiphenyl sulfone, or a combination comprising at least one of the foregoing.

### Embodiment 4

The method of any one of Embodiments 1 to 3, wherein melt mixing the composition occurs at a temperature of 300 to 450° C.

### Embodiment 5

The method of any one of Embodiments 1 to 4, wherein the pressure less than atmospheric pressure is less than or equal to 50,000 Pa, less than or equal to 25,000 Pa, less than or equal to 10,000 Pa, less than or equal to 5,000 Pa, or, less than or equal to 1,000 Pa.

### Embodiment 6

The method of any one of Embodiments 1 to 5, further comprising venting during melt mixing to remove water formed by the reaction.

### Embodiment 7

The method of any one of Embodiments 1 to 6, wherein the polyetherimide has a change in viscosity of less than or equal to 50% after being maintained for 30 minutes at 390° C. wherein melt viscosity is determined by ASTM D4440.

### Embodiment 8

The method of any one of Embodiments 1 to 7, wherein the polyetherimide has anhydride groups and amine groups and the anhydride-amine stoichiometry is continuously monitored by near infrared spectroscopy.

### Embodiment 9

The method of any one of Embodiments 1 to 8, wherein the polyetherimide has a −1 to 2.5 mol % or −1 to 1 mol % anhydride-amine stoichiometry.

### Embodiment 10

The method of any one of Embodiments 1 to 9, wherein the composition comprising an aromatic bis(ether anhydride) and a diamine further comprises a chain stopper.

### Embodiment 11

The method of Embodiment 10, wherein the chain stopper is present in an amount of 2 to 8 mol %.

### Embodiment 12

The method of Embodiment 10, wherein the chain stopper comprises phthalic anhydride or aniline.

### Embodiment 13

The method of any one of Embodiments 1 to 12, the polyetherimide has a change in melt viscosity of −30% to 50% after being maintained for 30 minutes at 390° C. wherein melt viscosity is determined by ASTM D4440.

### Embodiment 14

The method of any one of Embodiments 1 to 13, wherein melt mixing occurs at a temperature 50 to 150° C. greater than the glass transition temperature of the polyetherimide.

### Embodiment 15

A polyetherimide having a change in viscosity of less than or equal to 50% after being maintained for 30 minutes at 390° C. wherein melt viscosity is determined by ASTM D4440 and a solvent content less than 50 ppm.

Embodiment 16 The polyetherimide of Embodiment 15, wherein the polyetherimide comprises structural units derived from 2,2-bis[4-(3,4-dicarboxyphenoxy)phenyl]propane dianhydride and a diamine comprising m-phenylenediamine (mPD), p-phenylenediamine (pPD), 4,4′-diaminodiphenyl sulfone, 3,4′-diaminodiphenyl sulfone, 3,3′-diaminodiphenyl sulfone, or a combination comprising at least one of the foregoing.

### Embodiment 17

The polyetherimide of Embodiment 15 or 16, wherein the change in melt viscosity is less than or equal to 40%, less than or equal to 30%, or less than or equal to 20%.

### Embodiment 18

The polyetherimide of any one of Embodiments 15 to 17, wherein the polyetherimide has a chlorine content less than or equal to 100 ppm, or less than or equal to 50 ppm, or less than or equal to 25 ppm.

### Embodiment 19

The polyetherimide of any one of Embodiments 15 to 18, wherein the polyetherimide has an anhydride-amine stoichiometry of 2.5 to −1 mol %, or 1.0 to −1 mol %.

The compositions, methods, and articles can alternatively comprise, consist of, or consist essentially of, any appropriate materials, steps, or components herein disclosed. The compositions, methods, and articles can additionally, or alternatively, be formulated so as to be devoid, or substantially free, of any materials (or species), steps, or components, that are otherwise not necessary to the achievement of the function or objectives of the compositions, methods, and articles.

All ranges disclosed herein are inclusive of the endpoints, and the endpoints are independently combinable with each other (e.g., ranges of “up to 25 wt. %, or, more specifically, 5 wt. % to 20 wt. %”, is inclusive of the endpoints and all intermediate values of the ranges of “5 wt. % to 25 wt. %,” etc.). “Combinations” is inclusive of blends, mixtures, alloys, reaction products, and the like. The terms “first,” “second,” and the like, do not denote any order, quantity, or importance, but rather are used to distinguish one element from another. The terms “a” and “an” and “the” do not denote a limitation of quantity, and are to be construed to cover both the singular and the plural, unless otherwise indicated herein or clearly contradicted by context. “Or” means “and/or” unless clearly stated otherwise. Reference throughout the specification to “some embodiments”, “an embodiment”, and so forth, means that a particular element described in connection with the embodiment is included in at least one embodiment described herein, and may or may not be present in other embodiments. In addition, it is to be understood that the described elements may be combined in any suitable manner in the various embodiments.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this application belongs. All cited patents, patent applications, and other references are incorporated herein by reference in their entirety. However, if a term in the present application contradicts or conflicts with a term in the incorporated reference, the term from the present application takes precedence over the conflicting term from the incorporated reference.

Compounds are described using standard nomenclature. For example, any position not substituted by any indicated group is understood to have its valency filled by a bond as indicated, or a hydrogen atom. A dash (“-”) that is not between two letters or symbols is used to indicate a point of attachment for a substituent. For example, —CHO is attached through carbon of the carbonyl group.

As used herein, the term “hydrocarbyl” includes groups containing carbon, hydrogen, and optionally one or more heteroatoms (e.g., 1, 2, 3, or 4 atoms such as halogen, O, N, S, P, or Si). “Alkyl” means a branched or straight chain, saturated, monovalent hydrocarbon group, e.g., methyl, ethyl, i-propyl, and n-butyl. “Alkylene” means a straight or branched chain, saturated, divalent hydrocarbon group (e.g., methylene (—CH₂—) or propylene (—(CH₂)₃—)). “Alkenyl” and “alkenylene” mean a monovalent or divalent, respectively, straight or branched chain hydrocarbon group having at least one carbon-carbon double bond (e.g., ethenyl (—HC═CH₂) or propenylene (—HC(CH₃)═CH₂—). “Alkynyl” means a straight or branched chain, monovalent hydrocarbon group having at least one carbon-carbon triple bond (e.g., ethynyl). “Alkoxy” means an alkyl group linked via an oxygen (i.e., alkyl-O—), for example methoxy, ethoxy, and sec-butyloxy. “Cycloalkyl” and “cycloalkylene” mean a monovalent and divalent cyclic hydrocarbon group, respectively, of the formula —CₙH₂ₙ₋ₓ and —CₙH₂ₙ₋₂ₓ— wherein x is the number of cyclization(s). “Aryl” means a monovalent, monocyclic or polycyclic aromatic group (e.g., phenyl or naphthyl). “Arylene” means a divalent, monocyclic or polycyclic aromatic group (e.g., phenylene or naphthylene). “Arylene” means a divalent aryl group. “Alkylarylene” means an arylene group substituted with an alkyl group. “Arylalkylene” means an alkylene group substituted with an aryl group (e.g., benzyl). The prefix “halo” means a group or compound including one more halogen (F, Cl, Br, or I) substituents, which can be the same or different. The prefix “hetero” means a group or compound that includes at least one ring member that is a heteroatom (e.g., 1, 2, or 3 heteroatoms, wherein each heteroatom is independently N, O, S, or P.

“Substituted” means that the compound or group is substituted with at least one (e.g., 1, 2, 3, or 4) substituents instead of hydrogen, where each substituent is independently nitro (—NO₂), cyano (—CN), hydroxy (—OH), halogen, thiol (—SH), thiocyano (—SCN), C₁₋₆ alkyl, C₂₋₆ alkenyl, C₂₋₆ alkynyl, C₁₋₆ haloalkyl, C₁₋₉ alkoxy, C₁₋₆ haloalkoxy, C₃₋₁₂ cycloalkyl, C₅₋₁₈ cycloalkenyl, C₆₋₁₂ aryl, C₇₋₁₃ arylalkylene (e.g, benzyl), C₇₋₁₂ alkylarylene (e.g, toluyl), C₄₋₁₂ heterocycloalkyl, C₃₋₁₂ heteroaryl, C₁₋₆ alkyl sulfonyl (—S(═O)₂-alkyl), C₆₋₁₂ arylsulfonyl (—S(═O)₂-aryl), or tosyl (CH₃C₆H₄SO₂—), provided that the substituted atom's normal valence is not exceeded, and that the substitution does not significantly adversely affect the manufacture, stability, or desired property of the compound. When a compound is substituted, the indicated number of carbon atoms is the total number of carbon atoms in the group, including those of the substituent(s).

While particular embodiments have been described, alternatives, modifications, variations, improvements, and substantial equivalents that are or may be presently unforeseen may arise to applicants or others skilled in the art. Accordingly, the appended claims as filed and as they may be amended are intended to embrace all such alternatives, modifications variations, improvements, and substantial equivalents.

What is claimed is:

1. A method of making a polyetherimide comprising melt mixing a composition comprising an aromatic bis(ether anhydride) and a diamine to form a polyetherimide wherein melt mixing occurs at a temperature 50 to 225° C. greater than the glass transition temperature of the polyetherimide and after the composition attains a weight average molecular weight that is greater than or equal to 20% of the weight average molecular weight of the polyetherimide, melt mixing occurs at a pressure less than atmospheric pressure.

2. The method of claim 1, wherein the aromatic bis(ether anhydride) comprises bisphenol A dianhydride.

3. The method of claim 1, wherein the diamine comprises m-phenylenediamine (mPD), p-phenylenediamine (pPD), 4,4′-diaminodiphenyl sulfone, 3,4′-diaminodiphenyl sulfone, 3,3′-diaminodiphenyl sulfone, or a combination comprising at least one of the foregoing.

4. The method of claim 1, wherein melt mixing the composition occurs at a temperature of 300 to 450° C.

5. The method of claim 1, wherein the pressure less than atmospheric pressure is less than or equal to 50,000 Pa, less than or equal to 25,000 Pa, less than or equal to 10,000 Pa, less than or equal to 5,000 Pa, or, less than or equal to 1,000 Pa.

6. The method of claim 1, further comprising venting during melt mixing to remove water formed by the reaction.

7. The method of claim 1, wherein the polyetherimide has a change in viscosity of less than or equal to 50% after being maintained for 30 minutes at 390° C. wherein melt viscosity is determined by ASTM D4440.

8. The method of claim 1, wherein the polyetherimide has anhydride groups and amine groups and the anhydride-amine stoichiometry is continuously monitored by near infrared spectroscopy.

9. The method of claim 1, wherein the polyetherimide has a −1 to 2.5 mol % anhydride-amine stoichiometry.

10. The method of claim 1, wherein the composition comprising an aromatic bis(ether anhydride) and a diamine further comprises a chain stopper.

11. The method of claim 10, wherein the chain stopper is present in an amount of 2 to 8 mol %.

12. The method of claim 10, wherein the chain stopper comprises phthalic anhydride or aniline.

13. The method of claim 1, wherein the polyetherimide has a change in melt viscosity of −30% to 50% after being maintained for 30 minutes at 390° C. and melt viscosity is determined by ASTM D4440.

14. The method of claim 1, wherein melt mixing occurs at a temperature 50 to 150° C. greater than the glass transition temperature of the polyetherimide.

15. A polyetherimide having a change in viscosity of less than or equal to 50% after being maintained for 30 minutes at 390° C. and a solvent content less than 50 ppm, wherein melt viscosity is determined by ASTM D4440.

16. The polyetherimide of claim 15, wherein the polyetherimide comprises structural units derived from 2,2-bis[4-(3,4-dicarboxyphenoxy)phenyl]propane dianhydride and a diamine comprising m-phenylenediamine (mPD), p-phenylenediamine (pPD), 4,4′-diaminodiphenyl sulfone, 3,4′-diaminodiphenyl sulfone, 3,3′-diaminodiphenyl sulfone, or a combination comprising at least one of the foregoing.

17. The polyetherimide of claim 15, wherein the change in melt viscosity is less than or equal to 40%, less than or equal to 30%, or less than or equal to 20%.

18. The polyetherimide of claim 15, wherein the polyetherimide has a chlorine content less than or equal to 100 ppm, or less than or equal to 50 ppm, or less than or equal to 25 ppm.

19. The polyetherimide of claim 15, wherein the polyetherimide has an anhydride-amine stoichiometry of 2.5 to −1 mol %.
